(19) United States
(12) Patent Application Publication
(10) Pub. No.: US 2026/0002774 A1
(43) Pub. Date: Jan. 1, 2026

(54) SYSTEMS AND METHODS FOR INSPECTION OF CAMERA-ALIGNMENT

(71) Applicant: Google LLC, Mountain View, CA (US)

(72) Inventors: Guillermo Fabian Díaz Lankenau, Santa Cruz, CA (US); Alice Liu, San Francisco, CA (US); Punit Narendra Govenji, Pleasanton, CA (US); Alejandro Jose Troccoli, San Jose, CA (US); Andrew Huibers, Los Altos, CA (US); Antonio Yamil Layon Halun, Mountain View, CA (US)

(21) Appl. No.: 18/755,201

(22) Filed: Jun. 26, 2024

(51) Int. Cl. G01B 11/27

(52) U.S. Cl. CPC G01B 11/272

(57) ABSTRACT

A multi-camera display for a telepresence system may include a plurality of cameras aligned around a display panel large enough to display a person at scale. Aligning the cameras to particular directions can allow for images captured by the cameras to be combined to render a 3D image. The quality of the rendering may decrease when any or all of the cameras are misaligned. The present disclosure describes a system and method to test a frame assembly for a multi-camera display that uses mirrors and lasers to sense the camera alignments and targets to visually inspect the quality of the sensed camera alignments. Testing using this approach may simplify the testing because the alignments may be visually tested simultaneously, and the testing may be performed before the cameras are installed.

### FIELD OF THE DISCLOSURE

The present disclosure relates to a multi-camera device and more specifically to a system and method for inspecting the alignment of the multiple cameras.

### BACKGROUND

A telepresence conferencing system (i.e., telepresence system) can be used for audio/video communication between people. Some telepresence systems use a variety of techniques to enhance the realism of this communication in order to make a user feel like they are speaking in-person with another user. One technology used for this realism is the display. The display used in a telepresence system can be sized and positioned so that the user can view the person at an expected size (i.e., life-sized). Additionally, the display may be configured to display images that appear to be three-dimensional (3D). These 3D displays can require multiple images captured by a set of cameras configured to image a subject from multiple perspectives (i.e., multiple viewpoints).

### SUMMARY

A system and method for testing the alignment of at least one camera is disclosed. The test provides visual feedback of the alignment, and the feedback can be obtained simultaneously for multiple cameras.

In some aspects, the techniques described herein relate to a method including: coupling a mirror to a camera bracket, the camera bracket configured to hold a camera in a camera alignment, the mirror being aligned with the camera alignment; coupling the camera bracket with the mirror to a frame assembly; mounting the frame assembly to a support structure; activating a laser to radiate a laser beam to the mirror, the mirror generating a reflection of the laser beam; receiving the reflection at a backboard; and determining a position of the reflection on the backboard relative to a target on the backboard.

In some aspects, the techniques described herein relate to a testing system including: a first support structure including a frame mount configured to hold a frame assembly, the frame assembly including a plurality of mirrors aligned with a plurality of camera mounts; a second support structure spaced apart from the first support structure, the second support structure including a plurality of lasers corresponding to the plurality of mirrors, wherein the plurality of lasers are configured to radiate a plurality of laser beams to corresponding mirrors of the plurality of mirrors; and a backboard coupled to the second support structure, the backboard configured to receive the plurality of laser beams reflected from the plurality of mirrors, the backboard including a plurality of targets to visually display alignment of the plurality of camera mounts based on positions of the plurality of laser beams relative to the plurality of targets.

In some aspects, the techniques described herein relate to a system for testing a frame assembly of a multi-camera display prior to assembly, the system including: a first support structure configured to hold the frame assembly during a visual test of camera alignment, the frame assembly including camera brackets configured to hold cameras in positions, the camera brackets having mirrors aligned with the positions; a second support structure including laser mounts coupled to lasers, the lasers configured to radiate laser beams towards the mirrors; and a backboard coupled to the second support structure, the backboard including targets configured to receive the laser beams after being reflected from the mirrors.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a top view of a telepresence system according to a possible implementation of the present disclosure.

FIG. 2 is a perspective view of a multi-camera display according to a possible implementation of the present disclosure.

FIG. 3 is a front perspective view of a camera bracket for a multi-camera display according to a possible implementation of the present disclosure.

FIG. 4 is a top view of a frame assembly being tested according to a possible implementation of the present disclosure.

FIG. 5 is a perspective view of a testing system for a frame of a multi-camera display according to a possible implementation of the present disclosure.

FIG. 6 illustrates positions of reflections on a backboard relative to targets according to a possible implementation of the present disclosure.

FIG. 7 is a flowchart of a method for testing a frame assembly of a multi-camera display according to a possible implementation of the present disclosure.

The components in the drawings are not necessarily to scale relative to each other. Like reference numerals designate corresponding parts throughout the several views.

### DETAILED DESCRIPTION

Telepresence is a subset of videoconferencing, which provides an improved sense of realism to a user without requiring the user to wear any equipment. A telepresence system may include multiple cameras configured to capture images of a user from precisely aligned perspectives so that highly realistic 3D images of the user can be rendered. The cameras may be positioned around a display (i.e., multi-camera display) that is large enough to display a life-sized person.

Fabricating a multi-camera display having precise relative poses can be achieved by (i) manufacturing a structure (e.g., frame assembly) that places all cameras within a tight tolerance to their ideal position (i.e., placement/orientation), (ii) assembling the cameras onto the structure so that images of a target captured by the camera can be processed, and (iii) processing the images (e.g., using computer vision algorithms) to calibrate any remaining (and relatively small) position errors.

At least one technical problem with this approach is that parts of the multi-camera display may be manufactured at different locations before being collected and assembled into a multi-camera display by an integrator. As a result, parts that are out of tolerance may not be detected before the final system is assembled. Traditional inspection techniques for the parts at their point of origin may be challenging. For example, a frame assembly for a telepresence multi-camera display includes mounting features for the cameras that must be held within tight tolerances relative to each other. Measuring small position and orientation (i.e., pose) differences between mounting features on the frame assembly may be too difficult for existing metrology equipment because of the relatively large distances between the mounting features on the frame assembly. Posing each camera on the frame assembly after they are installed may also be problematic because it can introduce more complexity (e.g., adjustable mounts) than desirable and may be prone to change after assembly. Accordingly, a new testing system and method may be desirable to help test a frame assembly's ability to position cameras according to their specified positions in a telepresence system.

The present disclosure describes a testing system and testing method to address these technical problems. In particular, the disclosure describes a camera-alignment inspection approach for a frame assembly before the cameras are mounted. The disclosed testing system/method may have the technical effect of improving operation of a telepresence system without added cost and complexity. Further the disclosed testing approach may shorten fabrication times, which can enable high-volume production of the telepresence system.

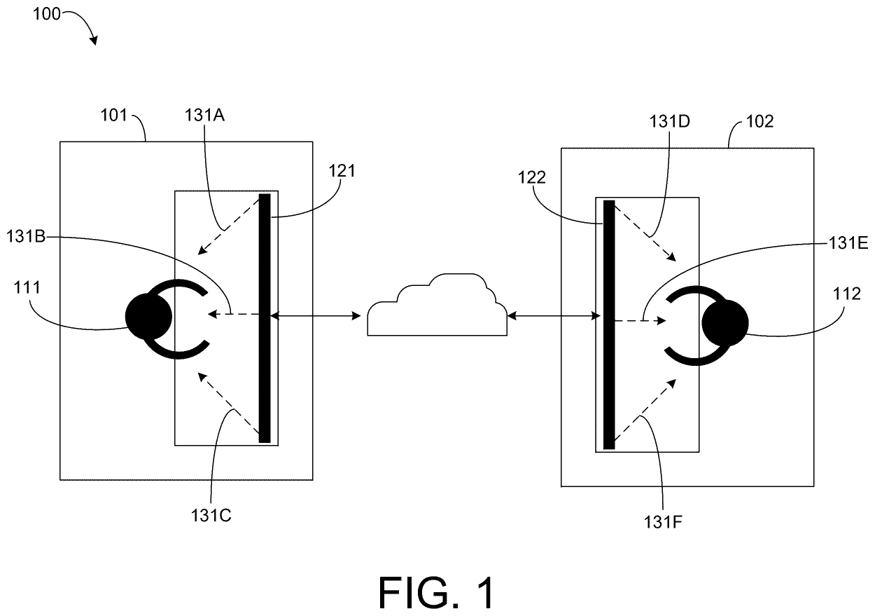

FIG. 1 illustrates a telepresence system 100 according to a possible implementation of the present disclosure. The telepresence system may include a plurality of stations that can be communicatively coupled together via a network 103 (e.g., internet). The stations may be identified based on their relationship to a user. For example, a local user uses a local station to communicate with a remote user at a remote station. The terms local and remote are therefore relative and may be used interchangeably, depending on a frame of reference.

A local station 101, at a first location, may be used by a local user 111 to communicate with a remote user 112 using a remote station 102 at a different location. The local user 111 may view 3D video of the remote user 112 on a local multi-camera display 121, while the remote user 112 may view 3D video of the local user 111 on the remote multi-camera display 122. To render the 3D video on the remote multi-camera display 122, the local multi-camera display 121 includes an array of cameras configured to capture images of the local user 111 from a plurality of perspectives 131A-C. Accordingly, a plurality of cameras may be mounted around the perimeter of the local multi-camera display 121 and are configured to capture images of the local user 111 from the plurality of perspectives 131A-C. Likewise, a plurality of cameras may be mounted around a perimeter of the remote multi-camera display 122 to capture images of the remote user 112 from a plurality of perspectives 131D-F. In a possible implementation a local multi-camera display 121 is the same as a remote multi-camera display 122.

The display in the telepresence system may be configured to display 3D images based on a stereoscopic technique that does not require a user (i.e., viewer) to wear glasses. In other words, the 3D images may be autostereoscopic. Instead, the display may project images spatially so that a user viewing the display may receive a first image of a stereoscopic pair at a left eye and a second image of the stereoscopic pair at the right eye. The display may include a first camera in a first position so it points in a first direction (i.e., has a first perspective) and the second image may be captured by a second camera in a second position so that it points in a second direction (i.e., has a second perspective. Images captured from the first perspective and second perspective may provide the different perspectives necessary for the user to perceive the scene in 3D in the direction of the difference. The principal may be expanded to include more than two cameras (e.g., six, seven, etc.) so that the 3D effect can be more realistic, especially as a view moves.

The rendering and display of the 3D images may require the cameras to accurately point in certain predetermined directions. In other words, when the positions (i.e., orientations and locations) of multiple cameras are known, the images from the multiple cameras can be combined and rendered on a 3D display designed according to these positions. Misalignments of any camera, or between cameras, can negatively affect the resulting 3D effect. Accordingly, it is important to determine that the positions of the cameras are within a tolerance as part of fabricating a multi-camera display, as described.

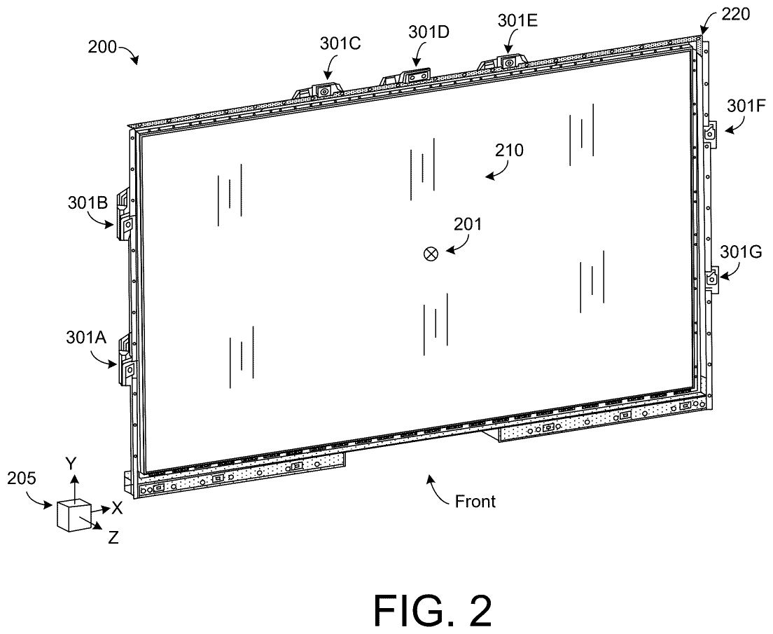

FIG. 2 is a perspective view of a multi-camera display according to a possible implementation of the present disclosure. The multi-camera display 200 includes a display panel 210 configured to display images (e.g., 3D images). The multi-camera display 200 further includes a frame 220 that surrounds and supports the display panel 210. The multi-camera display 200 may further include a plurality of camera modules 301A-G that are attached to the frame 220 at locations around the frame. Each camera module may include a camera bracket that is attached to bracket mounting features (i.e., bracket mounts) on the frame. Each camera bracket is configured to hold a camera in alignment with a direction determined by the camera bracket and the mounting feature. For example, the cameras of the camera modules 301A-G may be configured to point in different directions relative to a center 201 of the display. For example, cameras on a left portion of the frame 220 (i.e., camera modules 301A-B) may be rotated about a first axis parallel with the Y-direction of a coordinate system 205 (i.e., about a first vertical axis) towards the center 201. Cameras on a right portion of the frame 220 (i.e., camera modules 301F-G) may be rotated about a second axis parallel with a y-direction of the coordinate system 205 (i.e., about a second vertical axis shifted horizontally from the first vertical axis) towards the center 201. Cameras on a top portion of the frame 220 (i.e., camera modules 301C-E) may be rotated about a third axis parallel with the x-direction of the coordinate system 205 (i.e., horizontal axis) towards the center 201.

An alignment of a camera may include an alignment to a target direction (i.e., target position). The alignment of the camera may further include its alignment with the directions of one or more other cameras of the frame. For example, two cameras (e.g., camera modules 301B, 301F) may be aligned vertically but pointed in different (e.g., opposite) directions horizontally, and the alignment of the multi-camera display may include pairwise relationships, such as this, between cameras. When each camera in a pair is aligned to its corresponding target direction, then it can be assumed that the pairwise alignment may be aligned as well.

The alignment of a camera may deviate from a target (i.e., ideal, specified) alignment because of variations to the frame 220 and/or the bracket. In other words, the bracket (and the frame) may define a camera alignment (i.e., camera direction). The camera alignment for each camera module may be inspected (i.e., tested) for variations outside of a tolerance before the cameras and display panel are installed by using aligned a mirror that represents (e.g., is aligned with) the camera alignment.

Fabricating the multi-camera display 200 may include constructing a frame assembly (i.e., frame) before the display panel 210 or the cameras are installed. In other words, the frame assembly of the multi-camera display may include a plurality of camera brackets coupled to a frame.

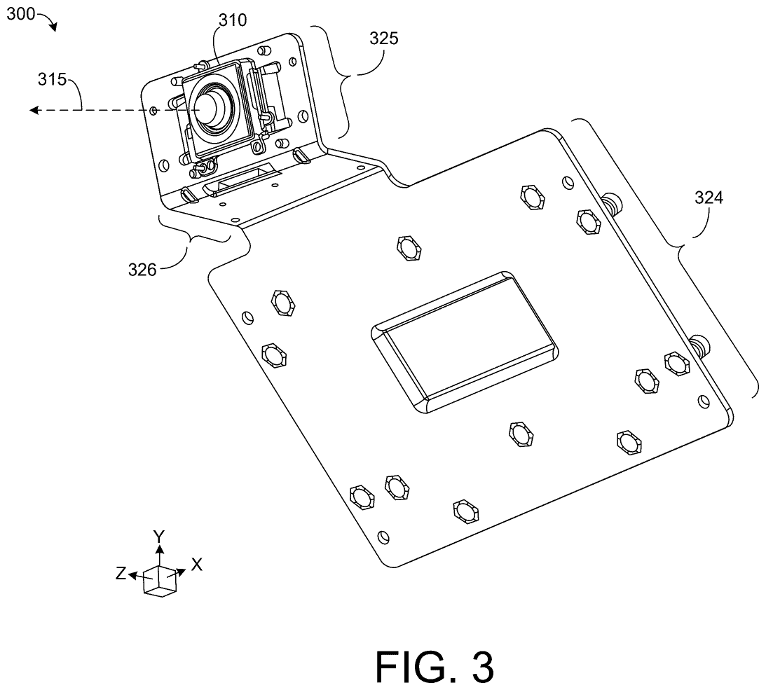

FIG. 3 is a front perspective view of a camera bracket for a multi-camera display according to a possible implementation of the present disclosure. The camera bracket 300 can include a camera mounting portion (i.e., camera mount 325) configured to support and position a camera 310 (when installed). The camera bracket 300 can include a frame mount portion (i.e., frame mount 324) configured to attach to bracket mounts on the frame 220 of the multi-camera display 200. The camera mount and the frame mount 324 may be positioned relative to each other by a coupling portion 326 of the camera bracket 300. As shown, the portions of the camera bracket 300 may have angles relative to each other that can determine an alignment of the camera after installation. The angles may result from bends made in the material (e.g., sheet of metal) made while fabricating the camera bracket 300. Variations in the angles can cause direction of an optical axis of the camera (i.e., a camera alignment 315) to deviate from a direction expected for the camera (i.e., a camera-alignment specification). When this deviation is larger than a tolerance (i.e., out of specification) the camera alignment 315 may not be suitable for capturing images that can be rendered in the 3D display properly. Accordingly, measuring (i.e., testing) the camera alignment 315 may be important to ensure proper operation (e.g., the realism) of a telepresence system.

While images captured by camera 310 may be used to measure the camera alignment 315. This approach requires installation of the camera 310 and its associated circuitry/processing, which may be unavailable, or inconvenient, at this stage in the production process. For example, the frame assembly may be fabricated at a first location and the camera and associated circuitry/process may be added to the frame assembly at a second location. The disclosed approach can measure the camera alignment 315 of the frame assembly without the cameras and without the associated circuitry/processing.

A mirror may be affixed to camera bracket 300 so that an optical axis of the mirror is aligned with, or otherwise in a known relationship with a camera alignment 315 provided by the camera mount 325. In other words, determining the optical axis of the mirror may help determine a direction of the optical axis of a camera (i.e., the camera alignment 315), which will exist after the camera 310 is installed. Put another way, a camera mount 325 may define a direction of a camera (i.e., camera alignment 315), and a mirror coupled to the camera mount 325 may help to measure this direction based on the reflection of a laser.

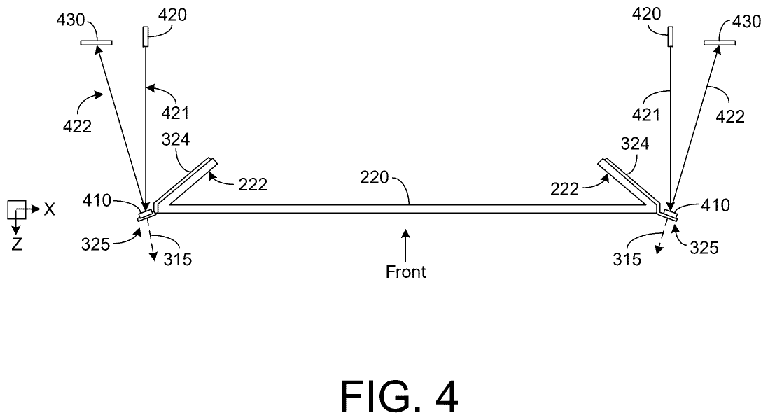

FIG. 4 is a top view of a frame assembly being tested according to a possible implementation of the present disclosure. As shown, the frame 220 includes a bracket-mount portion (i.e., bracket mount 222) on either side of the frame 220. A camera bracket 300 is attached at each bracket mount 222 to the frame 220. In other words, a frame mount 324 of the camera bracket 300 is coupled (e.g., directly coupled) to a bracket mount 222 of the frame 220. A mirror 410 is attached to the camera mount 325 of the camera bracket 300. In a possible implementation, the mirror 410 may be attached to a side of the camera mount 325 so that it faces an area behind the frame 220. For example, a reflecting surface of the mirror 410 may face a direction that is opposite to (i.e., 180 degrees from) the camera alignment 315 direction. The camera alignment 315 may be determined based on a measurement of the direction of the reflecting surface of the mirror 410 (i.e., the direction of the mirror 410).

The direction of the mirror 410 may be measured using a laser 420. The laser 420 may be activated to radiate a laser beam 421 to the mirror 410. The laser beam 421 may be in a direction that forms a first angle with the direction of the mirror 410. The mirror 410 may generate a reflection 422 in a direction that forms a second angle with the direction of the mirror 410. The first angle may equal the second angle on opposite sides of a direction normal to the reflecting surface of the mirror 410 (i.e., the direction of the mirror 410). The direction of the mirror 410 may be measured using a target 430 positioned at a location based on an expected direction (i.e., desired direction) of the mirror 410. The location of the reflection 422 on the target 430 may visually illustrate the direction of the mirror 410, which is aligned (at a 180-degree angle) with the camera alignment 315.

A test of the camera alignment 315 may be performed by determining the position of the reflections relative to each reflection's respective target. This approach is both simple and fast because the results may be obtained visually and simultaneously.

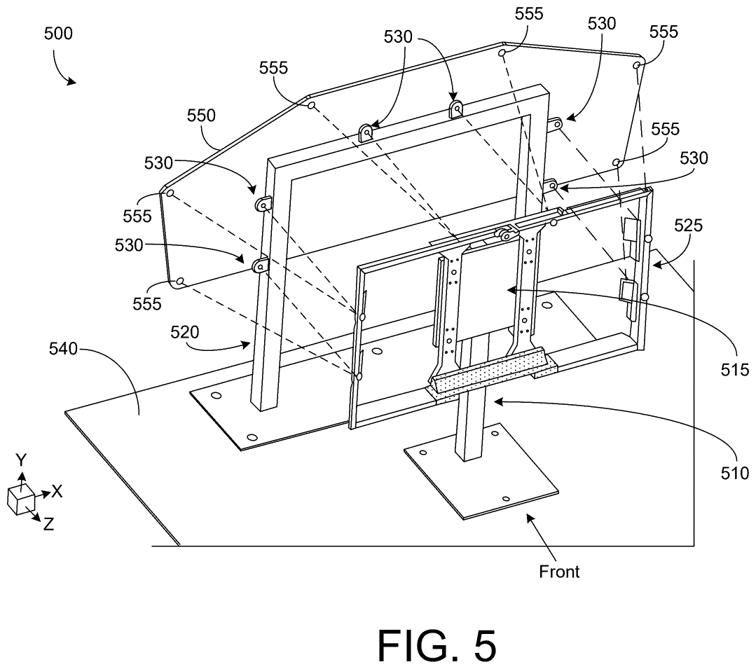

FIG. 5 is a perspective view of a testing system for a frame of a multi-camera display according to a possible implementation of the present disclosure. The testing system 500 includes a first support structure 510. The first support structure 510 includes a frame mount 515 to which a frame assembly 525 of a multi-camera display may be mounted for a test. The frame mount 515 may include features (e.g., a slot and hole) to align the frame assembly in the testing system while the frame assembly is being tested. The features may facilitate accurate mounting that is repeatable as frame assemblies are installed and uninstalled in the testing system.

At the beginning of a test, the frame assembly 525 may be coupled to the first support structure 510 so that mirrors of the frame assembly 525 face towards the second support structure 520. After the test the frame assembly 525 may be removed from the first support structure 510 and replaced with another frame assembly 525 for testing.

In a possible implementation, the first support structure 510 is fixedly coupled to a base (e.g., the floor) at a first position and the second support structure 520 is fixedly coupled to a base 540 (e.g., the floor) at a second position. A longitudinal (i.e., z-direction) separation between the first position and the second position may be selected in order to space a target apart from a laser by a lateral separation (i.e., x-direction).

The second support structure 520 includes at least one laser. As shown the second support structure 520 includes a plurality of lasers. A number of lasers on the second support structure 520 can equal a number of mirrors on the frame assembly 525. The second support structure 520 may have a size and shape based on a size and shape of the frame assembly 525 so that each laser 530 on the second support structure 520 can be positioned at locations corresponding with the locations of the mirror on the frame assembly 525.

Each laser 530 can be activated during a test (e.g., simultaneously activated) to radiate a laser beam to a corresponding mirror on the frame assembly 525. Each mirror may generate a reflection. The reflections from the mirrors can be received on a backboard 550, and the backboard may include a target 555 for each reflection. In general, a single laser or subset of the plurality of lasers may be activated for the test.

Each target 555 may correspond to a laser 530. The relative laser/target positions can be maintained by the testing system 500 so that the alignment of the camera mount (i.e., mirror) can be measured by visually observing the position of the laser beam on the backboard relative to the target.

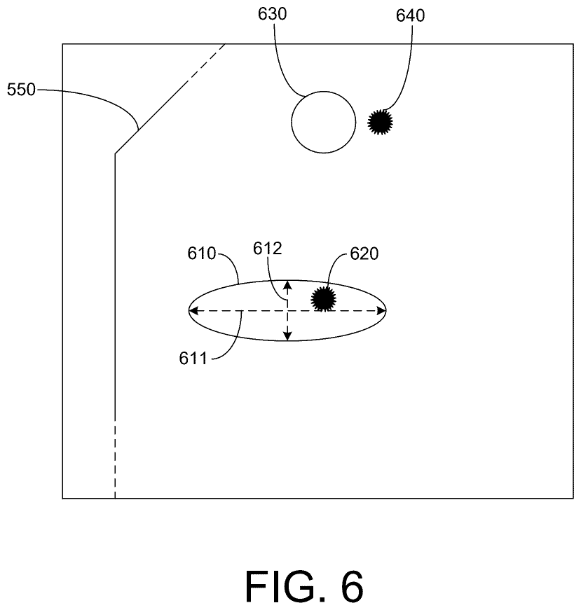

FIG. 6. illustrates positions of reflections on a backboard relative to targets according to a possible implementation of the present disclosure. The portion of the backboard 550 shown includes a first target 610 and a second target. 630. The targets may be marked, inlaid, machined, or otherwise created to visually highlight (e.g., outline) an area on the backboard. As shown, the targets may be sized and shaped differently according to different alignment specifications. In other words, the dimensions of the target may correspond to an alignment tolerance. The first target 610 is elliptically shaped according to a first tolerance in a first direction 611 (horizontal) and a second (smaller) tolerance in a second direction 612 (vertical). The second target 630 is circular, having the same tolerance in horizontal and vertical directions.

A test of camera alignment may pass when the position of a reflection (i.e., laser beam) on the backboard 550 is visually observed to be within the appropriate target. As shown, a first test of the camera alignment passes because a first laser beam 620 is within the first target 610. A second test of the camera alignment fails because a second laser beam 640 is not within the second target 630.

A test of a frame assembly may include simultaneously generating reflections of lasers on the backboard 550. A frame assembly can pass a visual test of camera alignment when all of the laser beams are within their corresponding targets. For example, the frame assembly generating the laser beams in FIG. 6 would fail the test of camera alignment because the second laser beam 640 is not within the second target 630.

When a laser fails to appear on the backboard 550 a test may fail due to gross misalignment. For example, when a laser fails to appear on the backboard may imply that the laser is not being reflected from the mirror. In a possible implementation a mirror may include an aperture to block laser beams from reaching the reflective surface when the camera mount is misaligned. In other words, the mirror may include a non-reflecting mask configured to reduce a reflecting area of the mirror (e.g., according to a tolerance).

The testing system 500 may include a test camera directed at the backboard, that can capture an image or video of the plurality of targets and the plurality of (reflected) laser beams. For example, a test camera may be mounted on the second support structure 520 and directed towards the backboard 550. The testing system 500 may further include a processor configured by software instructions to analyze the image to determine relative positions of the plurality of targets and the plurality of laser beams (i.e., laser spots). The processor may be further configured to indicate a pass of a test of the frame assembly 525 when each laser beam is within each (corresponding) target. To prevent a test from passing when a first laser is within a second target, the laser beams may be distinguished by temporally encoding (e.g., pulsing), spatially encoding (e.g., shaping), and/or color encoding the different laser beams of the testing system 500. The processor may be further configured to indicate a failure of the test when one or more of the pluralities of laser beams (e.g., any one of the laser beams) is not within the plurality of targets.

The testing system 500 may be initially calibrated by installing a frame assembly 525 with known good alignment (i.e., calibration frame assembly) into the testing system 500 and then adjusting the alignment of each laser so that it is within (e.g., centered) in its corresponding target. This calibration process may be performed at an initial setup and may then be repeated periodically to prevent errors in the testing.

After the test is complete and the frame assembly 525 passes, the cameras may be installed. In some implementations, each mirror 410 on the camera bracket may decoupled from the bracket (i.e., removed) after the test is complete. For the implementation shown in FIG. 4 the removal may be unnecessary because the mirror is not facing the front of the frame assembly. Accordingly, it may be possible to install the cameras without removing the mirrors. When the frame assembly fails the test of camera alignment, the cameras may not be installed.

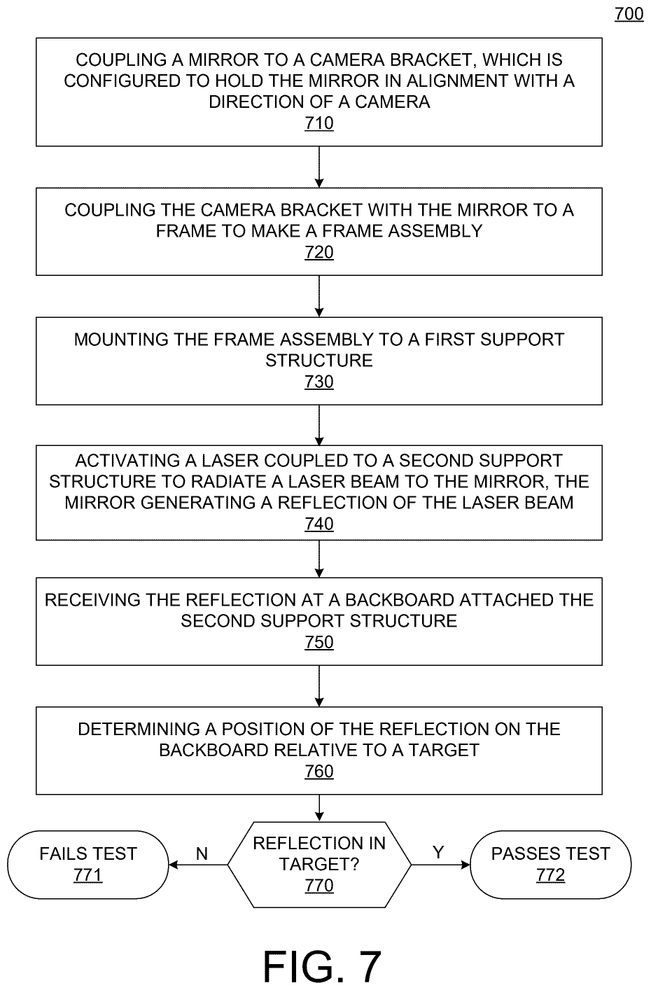

FIG. 7 is a flowchart of a method for testing a frame assembly of a multi-camera display according to a possible implementation of the present disclosure. The method 700 includes coupling 710 a mirror (or mirrors) to a camera bracket (or camera brackets). The mirror can be coupled to a camera mount 325 portion of the camera bracket 300 so that it is aligned with a direction that a camera will have after being installed. In other words, the mirror can be used to measure a camera alignment 315 before the camera is installed.

The method 700 further includes coupling 720 the camera bracket (or camera brackets) with the mirrors (or mirrors) to a frame to make a frame assembly. After the frame assembly is fabricated, it can be tested. Accordingly, the method includes mounting 730 the frame assembly to a first support structure 510 of a testing system 500 and activating 740 a laser (or lasers) coupled to a second support structure 520 of the testing system 500. The activated laser (or lasers) can radiate a laser beam (or laser beams) to the mirror (or mirrors) of the frame assembly.

The method 700 further includes receiving 750 a reflection (or reflections) from the mirror (or mirrors) at a backboard 550 mechanically coupled (i.e., attached) to the second support structure 520 of the testing system 500.

The method 700 further includes determining 760 (e.g., through human visual inspection or computer image analysis) a position (or positions) of the reflection (or reflections) on the backboard relative to the target (or targets) and determining 770 if the reflection (or reflections) is within the target (or targets). If the reflection (or reflections) is not within the target (or targets) then a test of the frame assembly fails 771 (i.e., is a failure) because the camera (or cameras) would be out of alignment if installed on the frame assembly. If the reflection (or reflections) is within the target (or targets) then a test of the frame assembly passes 772 because the camera (or cameras) will be in proper alignment when installed on the frame assembly.

The results of the testing process may cause or prevent further assembly of the multi-camera display. For example, the camera (or cameras) may not be installed on the camera bracket (or camera brackets) of the frame assembly until the test of the camera alignment is passed. In a possible implementation installing the camera may include decoupling the mirror from the camera bracket. For example, the mirror may be removed to make room for the camera on the camera bracket for implementation that includes mounting the mirror in place of the camera for the test. For the implementation illustrated in FIG. 4, the mirrors may not need to be removed because they are mounted on a back side of the camera bracket, which is opposite to the front side where the camera is mounted.

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Some implementations may be implemented using various semiconductor processing and/or packaging techniques. Some implementations may be implemented using various types of semiconductor processing techniques associated with semiconductor substrates including, but not limited to, for example, Silicon (Si), Gallium Arsenide (GaAs), Gallium Nitride (GaN), Silicon Carbide (SiC) and/or so forth.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
coupling a mirror to a camera bracket, the camera bracket configured to hold a camera in a camera alignment, the mirror being aligned with the camera alignment;
coupling the camera bracket with the mirror to a frame to make a frame assembly;
mounting the frame assembly to a support structure;
activating a laser to radiate a laser beam to the mirror, the mirror generating a reflection of the laser beam;
receiving the reflection at a backboard; and
determining a position of the reflection on the backboard relative to a target on the backboard.

2. The method according to claim 1, further comprising:
passing a test of the camera alignment when the position of the reflection on the backboard is within the target; and
failing the test of the camera alignment when the position of the reflection on the backboard is not within the target.

3. The method according to claim 2, further comprising:
installing the camera on the camera bracket based on the test of the camera alignment being passed.

4. The method according to claim 3, wherein installing the camera on the camera bracket includes:
decoupling the mirror from the camera bracket.

5. The method according to claim 2, further comprising:
not installing the camera on the camera bracket based on the test of the camera alignment being failed.

6. The method according to claim 1, further comprising:
performing a visual inspection to determine the position of the reflection on the backboard relative to the target on the backboard.

7. The method according to claim 1, further comprising:
capturing an image of the backboard, the reflection, and the target using a test camera; and
analyzing the image of the backboard, the reflection, and the target using a computer to determine the position of the reflection on the backboard relative to the target on the backboard.

8. The method according to claim 1, wherein the target is elliptically shaped according to a first tolerance in a first direction and a second tolerance in a second direction.

9. The method according to claim 1, wherein the mirror includes a non-reflecting mask configured to reduce a reflecting area of the mirror according to a first tolerance in a first direction and a second tolerance in a second direction.

10. The method according to claim 1, wherein:
the support structure is a first support structure fixedly coupled to a base; and
the laser and the backboard are mechanically coupled to a second support structure fixedly coupled to the base at a distance from the first support structure.

11. The method according to claim 1, wherein:
the frame assembly includes a plurality of mirrors coupled to a plurality of camera brackets having a plurality of camera mounts;
a second support structure includes a plurality of targets, each target corresponding one mirror of the plurality of mirrors; and
the second support structure further includes a plurality of lasers, each laser of the plurality of lasers configured to radiate a plurality of laser beams to corresponding mirrors of the plurality of mirrors, the plurality of mirrors generating a plurality of reflections;
wherein the method further includes:
determining alignments of the plurality of camera mounts simultaneously based on positions of the plurality of reflections relative to the plurality of targets; and
passing a test of the frame assembly when the positions of the plurality of reflections are within the plurality of targets.

12. A testing system comprising:
a first support structure including a frame mount configured to hold a frame assembly, the frame assembly including a plurality of mirrors aligned with a plurality of camera mounts;
a second support structure spaced apart from the first support structure, the second support structure including a plurality of lasers corresponding to the plurality of mirrors, wherein the plurality of lasers are configured to radiate a plurality of laser beams to corresponding mirrors of the plurality of mirrors; and
a backboard coupled to the second support structure, the backboard configured to receive the plurality of laser beams reflected from the plurality of mirrors, the backboard including a plurality of targets to visually display alignment of the plurality of camera mounts based on positions of the plurality of laser beams relative to the plurality of targets.

13. The testing system according to claim 12, wherein:
the first support structure is fixedly coupled to a base at a first position; and
the second support structure is fixedly coupled to the base at a second position, the first position and the second position separated by a distance along a direction of the plurality of laser beams.

14. The testing system according to claim 12, wherein the frame mount of the first support structure includes a slot and hole to align the frame assembly in the testing system while the frame assembly is being tested.

15. The testing system according to claim 12, wherein the frame assembly includes a plurality of camera brackets attached to a frame, each camera bracket including a camera mount of the plurality of camera mounts and a mirror of the plurality of mirrors, the mirror being directionally aligned with the camera mount so that a reflection of a laser beam from the mirror is in a direction of the camera mount.

16. The testing system according to claim 12, wherein:
the frame assembly includes a frame and a plurality of camera brackets attached to the frame at a plurality of positions spaced apart along a perimeter of the frame,
the plurality of mirrors are coupled to the plurality of camera brackets; and
the plurality of lasers are located on the second support structure so that each laser faces and is aligned with a corresponding mirror.

17. The testing system according to claim 12, further including:
a test camera configured to capture an image of the plurality of targets and the plurality of laser beams; and
a processor configured by software to:
analyze the image to determine relative positions of the plurality of targets and the plurality of laser beams;
indicate a pass of a test of the frame assembly when each laser beam is within each target; and
indicate a failure of the test when one or more of the plurality of laser beams is not within the plurality of targets, the test performed before a plurality of cameras are installed on the plurality of camera mounts.

18. The testing system according to claim 17, wherein:
the frame assembly is part of a multi-camera display of a telepresence system.

19. A system for testing a frame assembly of a multi-camera display, the system comprising:
a first support structure configured to hold the frame assembly during a visual test of camera alignment, the frame assembly including camera brackets configured to hold cameras in camera alignments, the camera brackets having mirrors aligned with the camera alignments;
a second support structure including laser mounts coupled to lasers, the lasers configured to radiate laser beams towards the mirrors; and
a backboard coupled to the second support structure, the backboard including targets configured to receive the laser beams after being reflected from the mirrors.

20. The system according to claim 19, wherein:
the frame assembly passes the visual test of the camera alignment when all the laser beams on the backboard are within the targets; and
the frame assembly fails the visual test of the camera alignment when one or more of the laser beams on the backboard is not observed within the targets.
